(19) United States
(12) Patent Application Publication
(10) Pub. No.: US 2014/0182544 A1
(43) Pub. Date: Jul. 3, 2014

(54) SYSTEM AND METHOD OF IMPROVING EFFICIENCY OF AN INTERNAL COMBUSTION ENGINE

(71) Applicant: Tongqing Zhou, Northville, MI (US)

(72) Inventor: Tongqing Zhou, Northville, MI (US)

(21) Appl. No.: 14/124,526

(22) PCT Filed: Jun. 25, 2012
(86) PCT No.: PCT/US12/44042

§ 371 Date: Mar. 3, 2014

(30) Foreign Application Priority Data
Jun. 29, 2011 (CN) 201110189527.X

(51) Int. Cl. F02B 17/00

(52) U.S. Cl. CPC F02B 17/005
USPC 123/294

(57) ABSTRACT

An improved multi-stroke DIG or diesel engine and method includes a cylinder formed within an engine cylinder block, a piston is movably disposed within the cylinder, and a combustion chamber is formed in a space between the piston and a cylinder head. An injector is disposed within the engine cylinder head for supplying fuel into the cylinder. An intake valve is disposed within an intake opening formed in the engine and an exhaust valve is disposed within an exhaust opening formed in the engine. An actuator is connected to the piston, wherein movement of the piston causes the actuator to open the exhaust valve a first predetermined amount at a beginning of the compression stroke of the piston to vent air through an exhaust channel formed in the engine and to close the exhaust valve after a predetermined period of time within the compression stroke of the piston.

### CROSS REFERENCE TO RELATED APPLICATIONS

This application claims the benefit of and prior to Chinese Patent Application Number 201110189527.X having a filing date of Jun. 29, 2011 and PCT application PCT/US2012/044042 filed on Jun. 25, 2012, the disclosures of which are hereby incorporated by reference in their entireties.

The present disclosure relates to an internal combustion engine and in particular to a system and method of improving combustion cycle efficiency in an internal combustion engine.

### BACKGROUND

Internal combustion (IC) engines are well known, and used in various applications in order to provide power, such as to operate a vehicle. The IC engine generates power through an engine cycle that involves a series of reciprocating strokes of the piston within a cylinder in the engine. Various types of engine cycles are generally known, including the Otto Cycle, diesel cycle, Wankel or rotary cycle, or Miller cycle. Enhancements to the internal combustion (IC) engine have improved the efficiency of the conventional engine operating cycles, resulting in improved fuel efficiency and reductions in exhaust emissions. An example of an enhancement is recirculation of exhaust gases back into the combustion chamber using a separate line from the exhaust manifold back into the intake manifold. Another example of an enhancement is to control the compression ratio to compensate for combustion gas energy lost during the exhaust blowdown stage. For a direct injection diesel (CI) engine, the necessary compression level is significantly greater than that of a corresponding spark ignited (SI) engine. CI engines typically utilize diesel fuel due to the thermal characteristics of diesel fuel. For a diesel engine, the engine cycle involves the compression of pure air in the cylinder and, at the end of the compression stroke, the diesel fuel is injected into the combustion chamber and ignited by the high temperature compressed air. The resultant gases which are formed in the cylinder by the combustion of the diesel fuel and hot air expand and thrust the piston downwards. Power is generated via the piston imparting a rotary motion to the crankshaft. The spent burned gases from the combustion stroke must then be exhausted from the cylinder and replaced by fresh air so that a new cycle can begin. The energy needed for affecting this portion of the engine cycle resulting in the discharge of spent gas and intake of fresh air within the cylinder is provided by the flywheel, or in an multiple cylinder engine, utilizing energy from another cylinder which is at the combustion stroke. The flywheel may store up some of the mechanical energy released during the combustion stroke. Further, the additional energy generated by the engine can be removed at the end of the crankshaft stroke.

Similarly, for a direct injected SI engine operating on a conventional gasoline fuel (DIG engine), thermal energy is released when the gasoline and air mixture is ignited as a result of the combustion stroke. For example, the DIG cycle may include the induction of air into the cylinder through induction valves prior to the compression stroke. Next, gasoline fuel is injected into the cylinder and mixed with the air. The gasoline and air mixture is compressed in the cylinder, and at the end of the compression stroke, the spark plug ignites the mixture, generating gases at a high temperature and high pressure. The gases expand and thrust the piston downwards, which imparts a rotary motion to the crankshaft. The spent burned gases must then be exhausted from the cylinder and are eventually replaced by a fresh gasoline and air mixture, so that a new cycle can begin. Various techniques may be utilized to store energy for the exhaust stroke, such as storing energy in the flywheel, or in an multiple cylinder engine, utilizing energy from another cylinder which is at the combustion stroke. Before the spent gases are discharged from the cylinder through the exhaust valve, the spent gases expand to about the same volume as that of the pure air when it begins to be compressed.

In most IC engines, the effective compression ratio is represented by the design compression ratio. For example, in a diesel engine, the compression ratio may be about 20:1, and the fresh air flowing into the cylinder is compressed to one twentieth of its original volume before the diesel fuel is injected into the combustion chamber to combust. In an example of a DIG engine, the compression ratio may be about 10:1, and the gasoline and air mixture in the cylinder is compressed to one tenth of its original volume before the spark plug ignites it to combust. Thereafter, hot gases generate high pressure and thrust the piston down. The hot gases can only expand the volume to about the volume of the air when the piston is at the bottom dead center (BDC) of the piston stroke. For example, gases may be expanded by about 20 times in the CI engine, and gases may be expanded by about 10 times in the DIG engine. Next, the exhaust stroke starts, the exhaust valve is opened and the gases are discharged out through the exhaust valve in the cylinder head. The discharged gases are very hot and still carry a lot of energy. Exhaust gas emission's high temperature and high pressure may limit raising the revolutions per minute (RPM) of the engine; however, restraining the RPM results in the engine being unable to generate more power.

Thus, there is a need in the art for a system and method of controlling an internal combustion engine that takes advantage of the energy generated during the combustion stroke that would otherwise be lost and reuses the waste energy to improve the overall efficiency of the engine.

### SUMMARY

Accordingly, a system and method of improving efficiency of an internal combustion engine is provided. The system includes a four stroke engine having a cylinder having a cylinder wall and a piston is movably disposed within the cylinder. The system further includes an injector for supplying fuel into the cylinder, an exhaust valve having a valve spring, and a camshaft having an exhaust cam. Each exhaust cam includes dual noses, and one of the dual exhaust noses opens the exhaust valve a first predetermined amount at the beginning of the compression stroke of the piston and closes the exhaust valve during the compression stroke of the piston and the other nose opens the exhaust valve a second predetermined amount during an exhaust stroke of the piston.

A method for improving the efficiency of a four-stroke DIG engine, includes the steps of initiating an induction stroke and inducting air into a combustion chamber situated within a cylinder while an induction valve is open. The method further includes the step of opening an exhaust valve a first predetermined amount during an early stage of the compression stroke for a predetermined period of time and closing the exhaust valve. Gasoline is injected into the combustion chamber during a later stage of the compression stroke while the induction valve and exhaust valve are closed. The method still further includes the step of generating thrust during a thrust stroke while both the induction valve and exhaust valve are closed, and during an exhaust stroke, releasing exhaust gases while the exhaust valve is open a second predetermined amount.

A method for improving the efficiency of a four-stroke CI engine includes the steps of initiating an induction stroke and inducting air into a combustion chamber situated within a cylinder while an induction valve is open. The method also includes the step of opening the exhaust valve a first predetermined amount during an early stage of the compression stroke and closing the exhaust valve. Air is compressed during a later stage of the compression stroke while the induction valve and exhaust valve are closed. The method further includes the steps of injecting fuel during a thrust stroke into the combustion chamber and generating thrust while both induction valve and exhaust valve are closed. The method still further includes the step of releasing exhaust gases during an exhaust stroke, while the exhaust valve is open second predetermined amount.

Advantageously, a system and method of improving thermal efficiency of an internal combustion engine is provided that captures and uses energy that would otherwise be lost during the combustion stroke and exhaust stroke. An advantage of the present disclosure is that the thermal energy contained by the heated gases. can be converted into useful work. Another advantage of the present disclosure is realized through reduced fuel consumption due to increased thermal efficiency of the engine. Still another advantage of the present disclosure is realized through cleaner emission gases as the fuel has greater expanding period to burn during the thrust stroke. Still yet another advantage of the present disclosure is that the average temperature of the gases in the cylinder is lower. A further advantage of the present disclosure relates to the ability of engine components to have a longer lifecycle and the life of the engine will likewise be longer. Still a further advantage of the present disclosure is that RPM of the engine can be raised to generate more power without excessive wear on the engine. Yet a further advantage of the present application is that part of the fresh air inducted into the cylinder during the induction stroke is discharged out of the cylinder through the exhaust valve(s) by the piston at an early stage of the compression stroke to cool the exhaust valves and the exhaust valve seats. Yet still a further advantage of the present application is that the system and method may be applied to a compression ignited engine, which can operate within an actual compression ratio of around 16:1-50:1 while still keeping the effective CR about 14:1-25:1. Yet still another advantage of the present application is that the system and method may be applied to a direct injected spark ignited engine which can operate with an actual compression ratio of 14:1-25:1 with an effective compression ratio of around 8:1-11:1.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is a block diagram of a system for improving the efficiency of an internal combustion engine.

FIG. 2a is a sectional view of a DIG engine during an induction stroke.

FIG. 2b is a sectional view of a CI engine during an induction stroke.

FIG. 3a is a sectional view of the DIG engine during an early compression stroke.

FIG. 3b is sectional view of the CI engine during an early compression stroke.

FIG. 4a is a sectional view of the DIG engine during a later compression stroke.

FIG. 4b is a sectional view of the CI engine during a later compression stroke.

FIG. 5a is a sectional view of the DIG engine during a thrust stroke.

FIG. 5b is a sectional view of the CI engine during a thrust stroke.

FIG. 6a is a sectional view of the DIG engine during an exhaust stroke.

FIG. 6b is a sectional view of the CI engine during an exhaust stroke.

FIG. 7 is a perspective view of a section of a single camshaft.

FIG. 8 is a diagrammatic end view illustrating the relative rotation of the cam.

FIG. 9 is a flowchart illustrating a method of operating a DIG engine.

FIG. 10 is a flowchart illustrating a method of operating a CI engine.

### DESCRIPTION

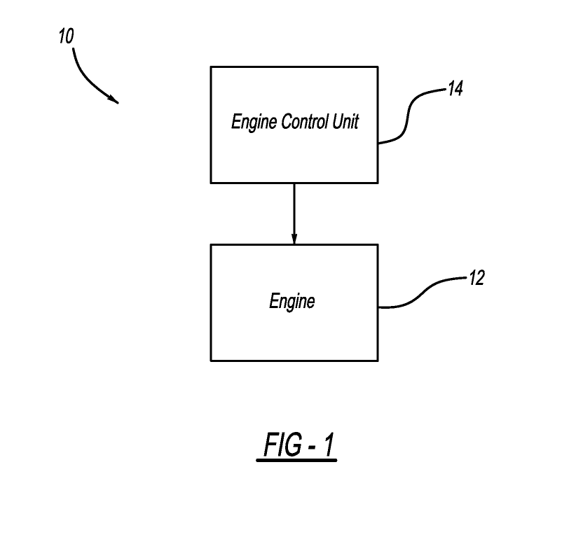

Referring to FIG. 1 a system 10 for providing power to operate a vehicle is illustrated. The system 10 includes an engine 12 and a controller 14. The system 10 may be incorporated in various types of vehicles, such as an automotive vehicle, or the like. In an example the engine 12 is a four stroke internal combustion diesel engine and in another example a direct injection spark ignited gasoline engine. The controller 14 may be a processor that includes a memory. The teachings provided herein can be utilized in any other type of reciprocating engine, such as a rotary engine, two stroke engine or some variation thereof.

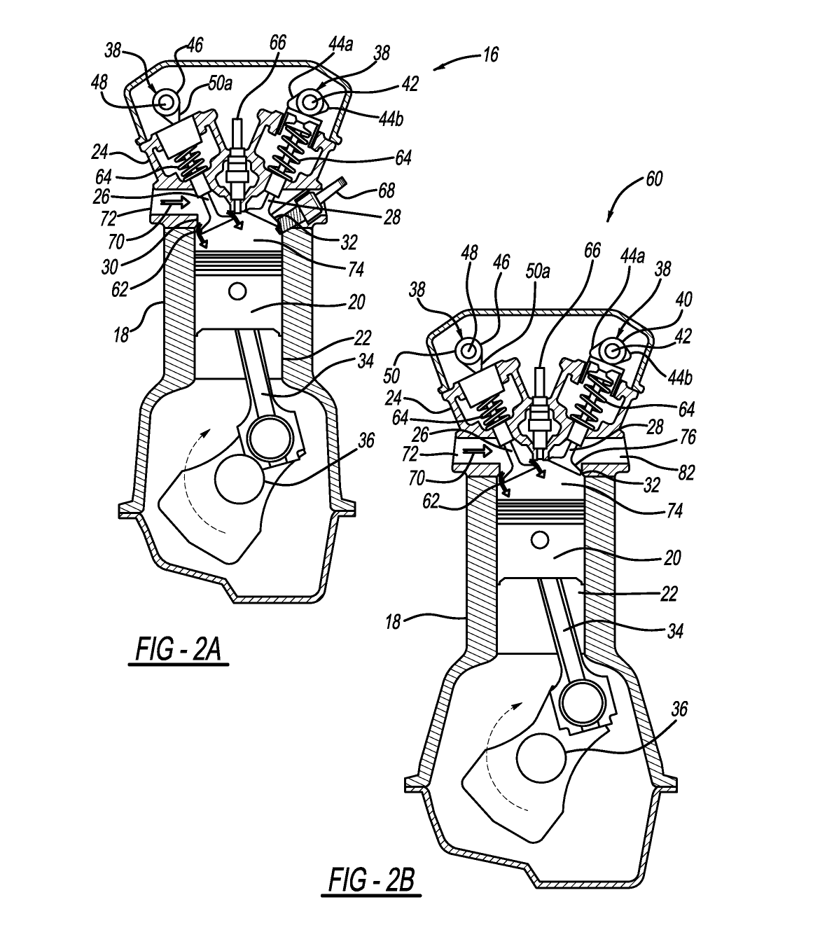

Referring to FIGS. 2a-6b, the various cycles of engine operation are illustrated for a DIG and CI engine respectively. As shown in FIGS. 2a, 3a, 4a, 5a and 6a, the DIG engine 16 includes a housing, referred to as an engine cylinder block 18. A piston 20 is operatively disposed within a cylinder 22 formed in the engine cylinder block. The engine cylinder block 18 may have a plurality of cylinders 22 with a predetermined arrangement, such as a “V” or in-line, and there may be 4, 6, 8 or more cylinders. The selection of cylinders 22 and arrangement is non-limiting. The DIG engine 16 may also have a cylinder head secured to the engine cylinder block 18. An intake valve 26 and exhaust valve 28 may be disposed within a corresponding intake port 30 or exhaust port 32 located in the cylinder head 24 to control airflow into and out of the cylinder 22. The piston 20 is connected via a connecting rod 34 to a crankshaft 36. The DIG engine 16 also includes an actuator 38 such as a camshaft that opens or closes the corresponding intake valve 26 or exhaust valve 28 associated with the particular cylinder 22 at predetermined times during a piston stroke in a manner to be described.

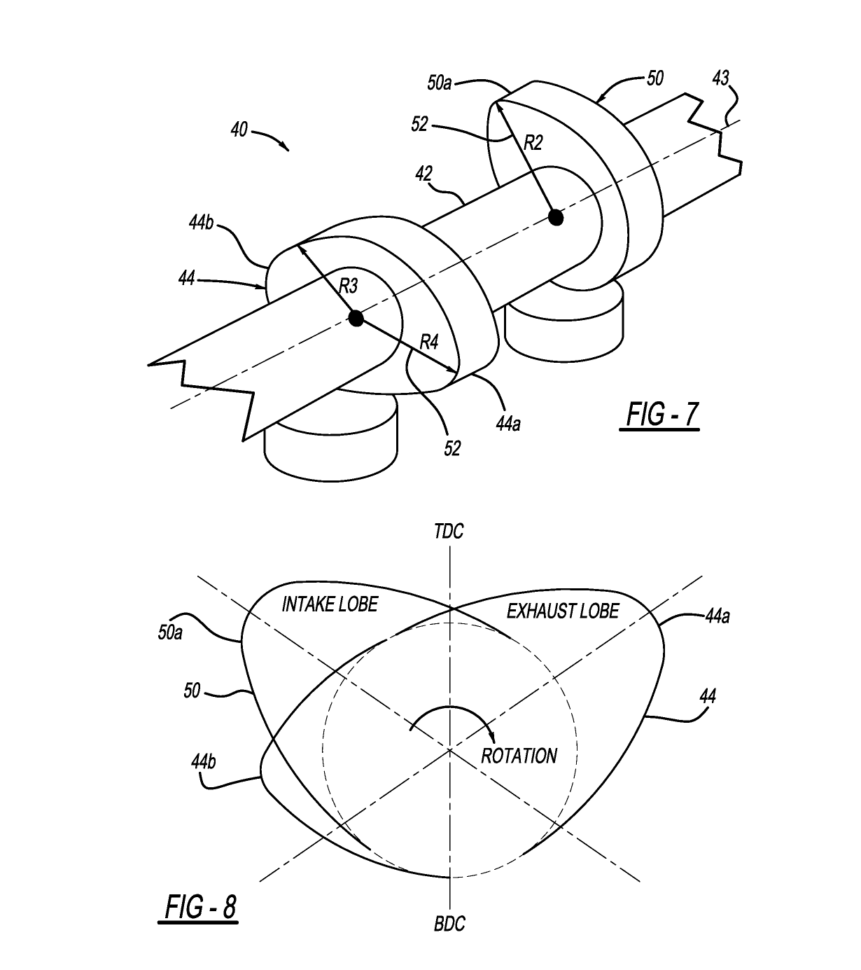

As shown in further detail in FIGS. 7-8, the exhaust camshaft 40 includes a cylindrical shaft 42 having one or more exhaust cams 44 mounted thereto. The exhaust cam 44 and shaft 42 may be integrally formed as one member. The rotational movement of the exhaust cam 44 operatively controls the exhaust valve 28. The DIG engine 16 may also include an induction camshaft 46 having an induction cam 50 mounted to a shaft 48 for controlling the air induction valve 26. Various arrangements of camshafts are contemplated, such as only having an exhaust cam 44 mounted thereto, only having an intake or induction cam 50 mounted thereto, or having both an induction cam 50 and exhaust cam 44 mounted to a single shaft.

Either the exhaust cam 44 or induction cam 50 is a generally cylindrical segment, with a centrally located bore that the shaft extends therethrough. The cam and shaft may be integrally formed as one-piece. Each cam 44, 50 has two generally planar flat walls which are non working surfaces. A cylindrical wall, which is the working surface, connects the boundaries of the two flat walls. Each cam 44, 50 further has a predetermined shape that is configured to actuate the corresponding valve due to the rotational movement of the cam 44, 50 about the shaft. Each cam 44, 50 may be essentially egg shaped, since the cylindrical wall has a variable radius with respect to a rotational axis 43 associated with the shaft, as shown at 52. For the exhaust cam 44, a first portion of the sidewall, referred to as a big nose, has a longer first radius to form a first arcuate edge as shown at 44a. The exhaust cam 44 also has a second portion of the cylindrical wall, referred to as a small nose, which has a smaller second radius, to form a second arcuate edge as shown at 44b.

The induction cam 50 has only one nose, just like the cams in the conventional IC engines. The nose has a long radius to form the only arcuate edge as shown at 50a. The induction cam 50 and exhaust cam 44 can each have different shapes to achieve predetermined timing to operatively open, hold open and close the corresponding induction and exhaust valves 26, 28 in a manner to be described.

As shown in FIGS. 2b, 3b, 4b, 5b and 6b, the CI engine 60 includes similar components as the DIG engine 16, with like components have like reference numerals. Both the DIG engine 16 and CI engine may include other conventionally known components, such as injectors, valve stems, rocker arms, ports, head, a valve cover, oil pan, or water jacket.

Referring back to FIGS. 2a and 2b, an induction stroke for a DIG engine 16 and CI engine 60 respectively is illustrated. During the induction stroke, the induction valve 26 is in an open position as shown at 62 and the exhaust valve is closed as shown at 76, while the piston 20 is moving downwardly. In the open position of either the DIG engine 16 or CI engine 60 of this example, the arcuate edge or nose 50a of the induction cam 50 presses down on a top portion of the induction valve 26 causing the induction valve 26 to move downwardly against the biasing action of the valve spring 64 and causing the valve spring 64 to compress. As the induction valve 26 moves downwardly, induction air as shown at 70 flows through an induction channel 72 located within the cylinder head and enters into a combustion chamber 74. At the end of the induction stroke, the rotational movement of the induction cam nose, or arcuate edge 50a releases the induction valve 26 and a valve spring 64 pushes the induction valve 26 upwardly to a closed position. The combustion chamber is defined by a space located between the cylinder head and a head portion of the piston 20. The piston is connected to a crank shaft 36 via a connecting rod 34 and actuates the piston 20 within the cylinder 22.

As shown in FIG. 2a for the example of a DIG engine 16, the induction valve 26 is open during the induction stroke as shown at 62. The induction valve 26 is opened by the nose or arcuate edge 50a of the induction cam 50, due to rotation of the induction camshaft 46. In this example, the induction camshaft 46 and exhaust camshaft 40 are each rotatably situated above the cylinder head 24. The DIG engine 16 includes a fuel injector 66 that is disposed in the cylinder head 24. Also in this example, a spark plug 68 may be situated within the cylinder head 24. The fuel injector and the spark plug 68 are inactive during the induction stroke. As previously described, the induction valve 36 is opened by a nose portion 50a of an induction cam 50 via the rotational movement of the induction camshaft 46.

In an example of a CI engine 60 as shown in FIG. 2b, the induction valve 26 is likewise open during the induction stroke as shown at 62. The induction valve 26 is opened by the nose or arcuate edge 50a of the induction cam 50, due to rotation of the induction camshaft 46. The exhaust valve 28 is closed at this time. The induction camshaft 46 and exhaust camshaft 40 may each be rotatably situated above the cylinder head 24. An injector 66 for injecting fuel into the combustion chamber is disposed in the cylinder head 24. The fuel injector 66 is inactive during the induction stroke.

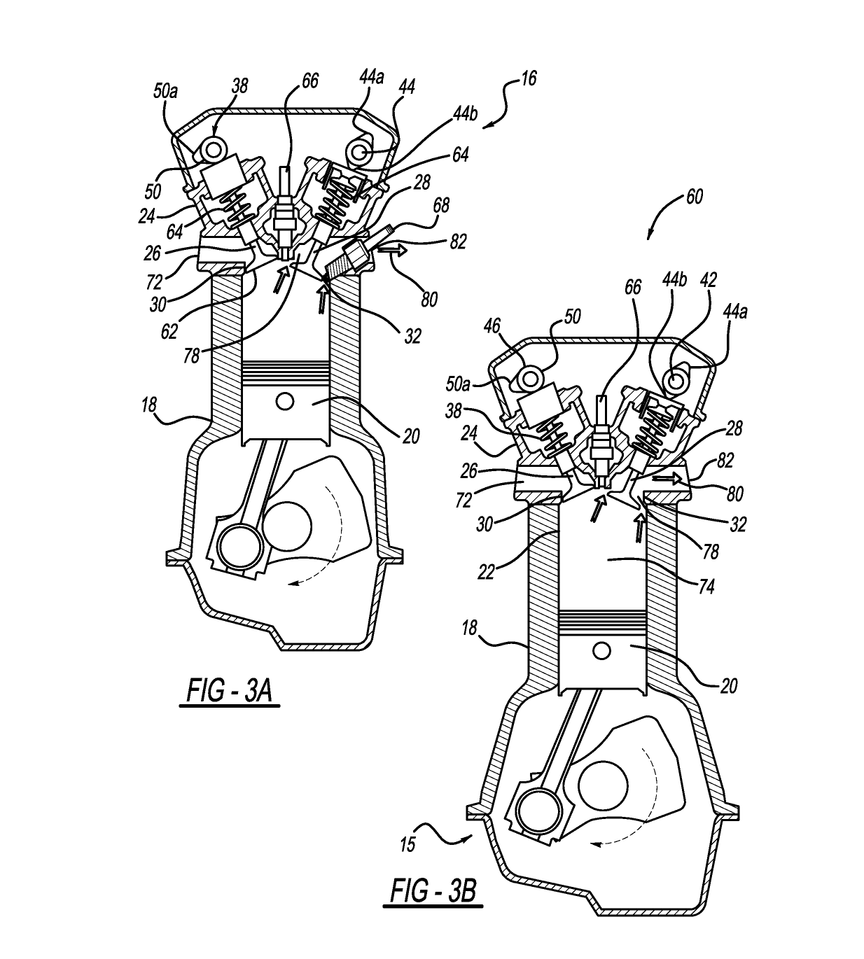

Referring now to FIGS. 3a and 3b, during an early stage of the compression stroke, the induction valve 26 is closed. As shown in FIG. 3a for a DIG engine 16, during the early stage of the compression stroke, the exhaust valve 28 is opened a first predetermined amount as shown at 78 due to the rotational movement of the exhaust cam 44 on the exhaust camshaft 40. The second arcuate edge or small nose 44b of the exhaust cam 44 presses down on a top portion of the exhaust valve 28, causing the exhaust valve 28 to move downwardly against the biasing action of the spring 64. As shown at 80, air is released through an exhaust channel 82. The release of air 80 during the early compression stroke reduces the density of the compressed air in the combustion chamber and allows for the removal of a predetermined amount of heat from sources such as an inner surface of a combustion chamber wall, a cylinder, an exhaust valve, an exhaust valve seat, or the like. Advantageously, the top engine RPM may be raised as a result of the combustion chamber temperature reduction. In additional, lightweight materials such a aluminum may be utilized due to the temperature reduction. The spark plug may be inactive during the early stage of the compression stroke.

As shown in FIG. 3b for a CI engine, the exhaust valve 28 is opened a first predetermined amount as shown at 78 by the engagement of the second arcuate edge or small nose 44b of the exhaust cam 44 during the early phase of the compression stroke. As shown at 80, a predetermined amount of air in the cylinder 22 is discharged through the opened exhaust valve 28 and via an exhaust channel 82. As the piston 20 is still moving in an upward direction, the continued rotational movement of the exhaust cam 44 releases the exhaust valve 28 and the exhaust valve 28 closes. It should be appreciated that the fuel injector 66 may be inactive during the compression stroke. Thereafter the closing the of exhaust valve 28, the later stage of the compression stroke starts.

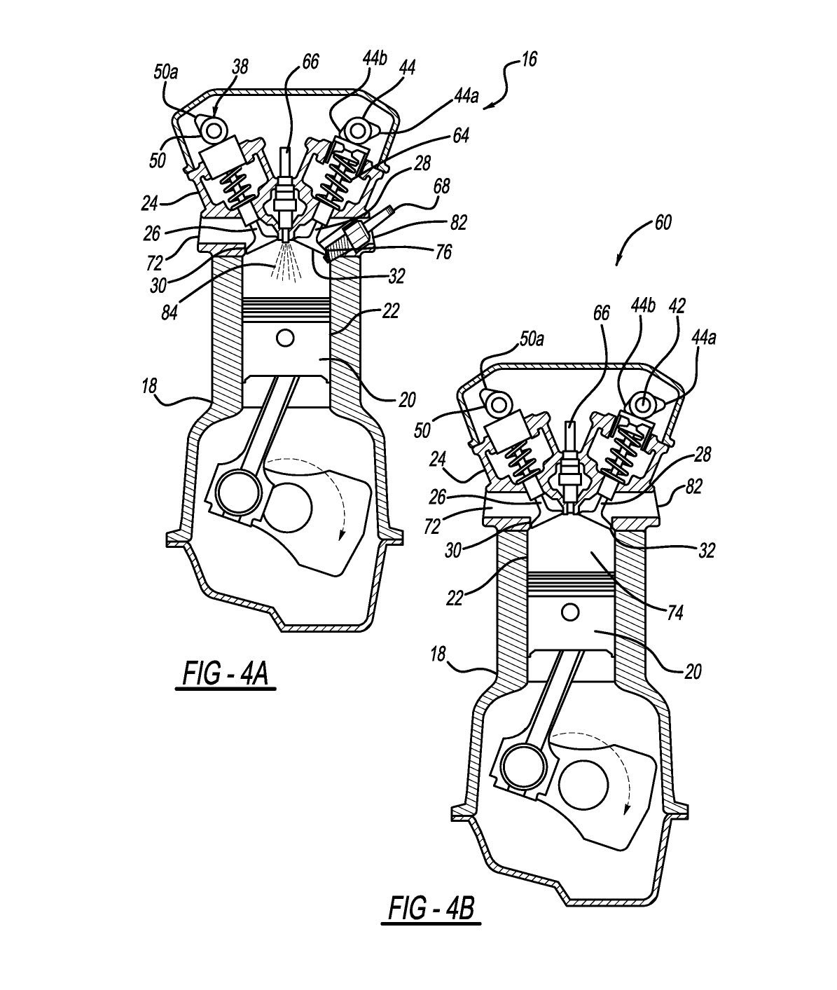

Referring now to FIGS. 4a and 4b, the late stage of the compression stroke is illustrated. The exhaust valve 28 is closed as shown at 76. The piston 20 continues to move and compress the remaining air in the cylinder 22. In the example of the DIG engine 16, the fuel injector 66 injects fuel 84, such as gasoline, into the combustion chamber 74. The spark plug 68 has not yet ignited. In the example of the CI Engine of FIG. 4b, the fuel injector 66 has not yet injected the fuel 84 into the combustion chamber 74.

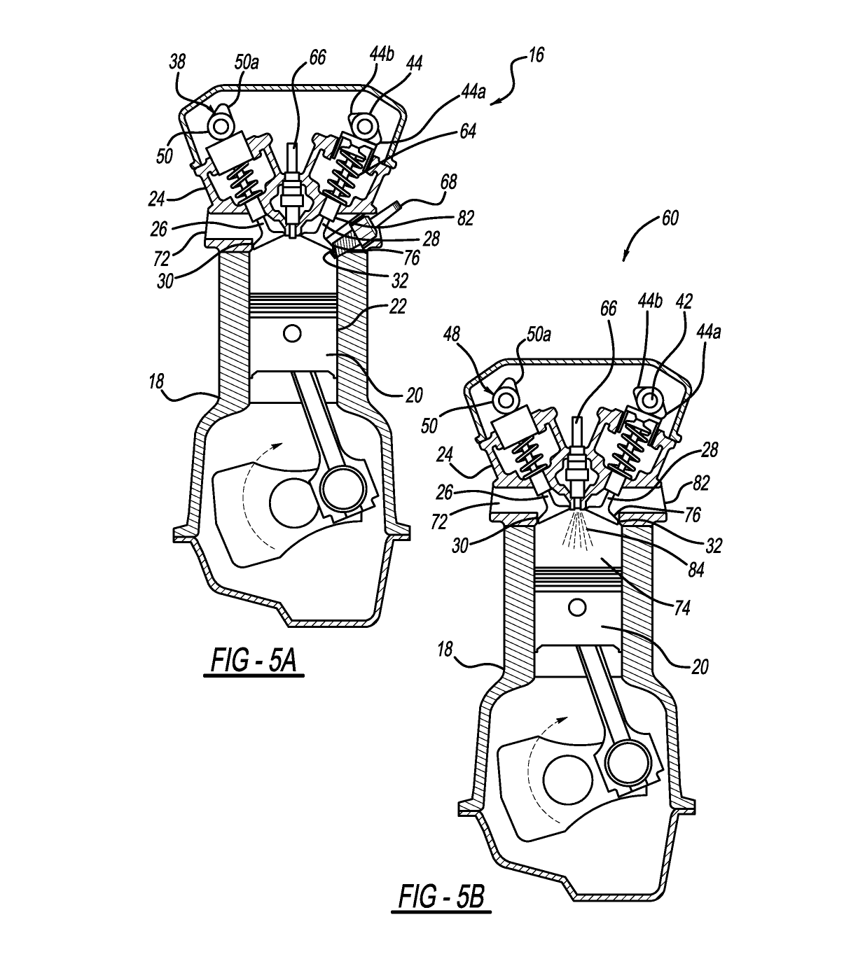

Referring now to FIGS. 5a and 5b, during the thrust or power stroke, both the induction valve 26 and exhaust valve 28 are closed. In the example of the DIG engine 16 shown in FIG. 5a, the injector can be inactive or active while the spark plug 68 fires. The firing of the spark plug may occur when the piston is near the top of the compression stroke. In the corresponding example of the CI engine 60 of FIG. 5b, the fuel injector 66 starts to inject fuel 84 when the piston 20 is near the top of its compression stroke, and stops the injection during the thrust stroke.

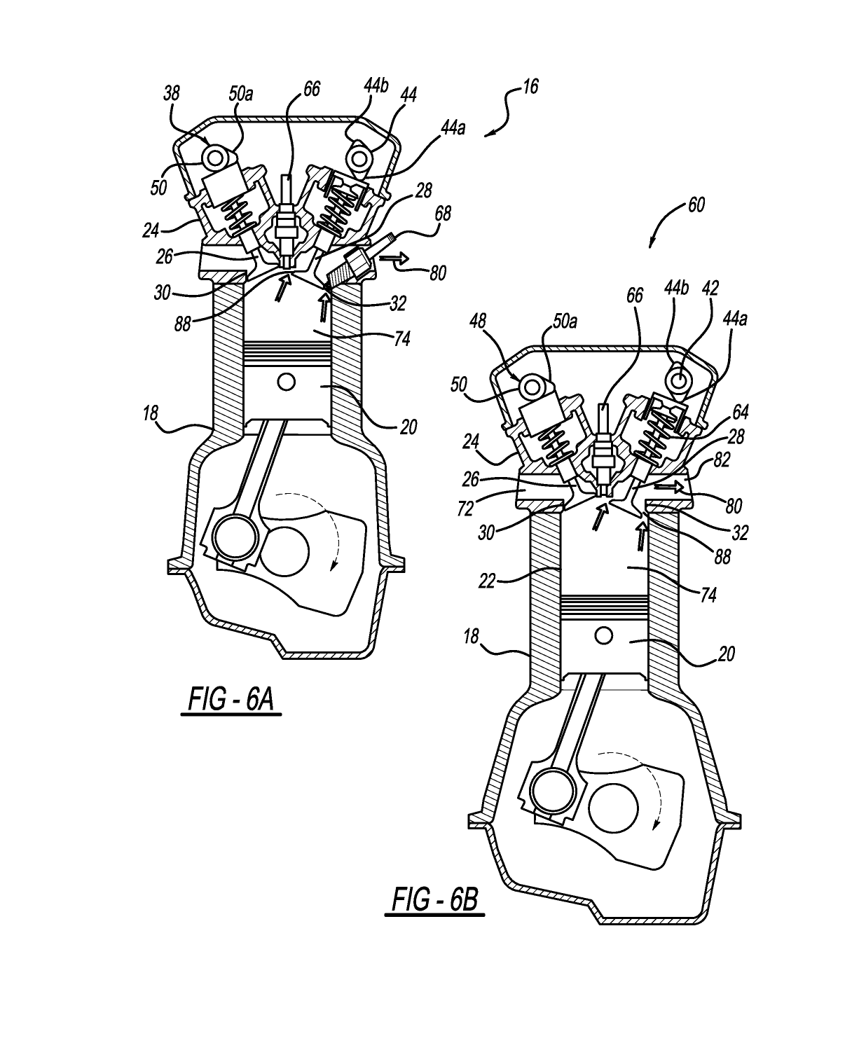

Referring now to FIGS. 6a, and 6b, combustion gas 80 is discharged from the cylinder 22 due to the opening of the exhaust valve 28 by the exhaust cam 44 a second predetermined amount as shown at 88. Note that the second predetermined opening 88 is greater than the first predetermined opening 78. At the end of the exhaust stroke of the engine, the piston 20 is located at the top dead center (TDC) with respect to the cylinder 22. As the piston 20 moves downwardly again due to rotation of the crankshaft 52, the next induction stroke is initiated and a new cycle begins.

Referring to FIG. 6a, during the exhaust stroke of the DIG engine 16, the exhaust valve 28 is opened a second predetermined amount 88 by the first arcuate edge or big nose 44a of the exhaust cam 44 due to rotational movement of the exhaust camshaft 40. The combusted gas 80 is vented via the exhaust channel 82. In this example, the fuel injector 66 and the spark plug 68 remain inactive during the exhaust stroke.

During the exhaust stroke of the CI engine 60 as shown in FIG. 6b, the exhaust valve 28 is similarly opened a second predetermined amount 88 by the big nose portion 44a of the exhaust cam 44 via rotational movement of the exhaust camshaft 40. The fuel injector 66 remains inactive during the exhaust stroke.

Referring back to FIGS. 7 and 8, an example of a single camshaft having both an induction cam 44 and an exhaust cam 50 mounted thereto is illustrated. The induction cam 50 has arcuate edge or nose 50a. The exhaust cam 44 has dual noses, that is a first arcuate edge or big nose 44a and a second arcuate edge or second nose 44b, and the second nose is smaller than the first nose.

Referring to FIG. 8, rotation of the single camshaft of FIG. 7 throughout the piston stroke is illustrated. There is a correspondence between a rotation of the induction cam 50 and exhaust cam 44 with the reciprocating movement of a piston 20 between a top dead center and a bottom dead center. With the foregoing rotation, the exhaust cam 44 opens an exhaust valve using the second arcuate edge or small nose 44b at the beginning of a compression stroke for a predetermined period of time. After a predetermined period of time, in the later stage of the compression stroke, the exhaust cam 44 keeps the exhaust valve closed. The exhaust cam 44 opens the exhaust valve 28 again using the first arcuate edge or big nose 44a during an exhaust stroke and the exhaust valve is kept open for a predetermined period of time. In an example, the exhaust valve may be opened for a longer period of time during the exhaust stroke than at the beginning of the compression stroke.

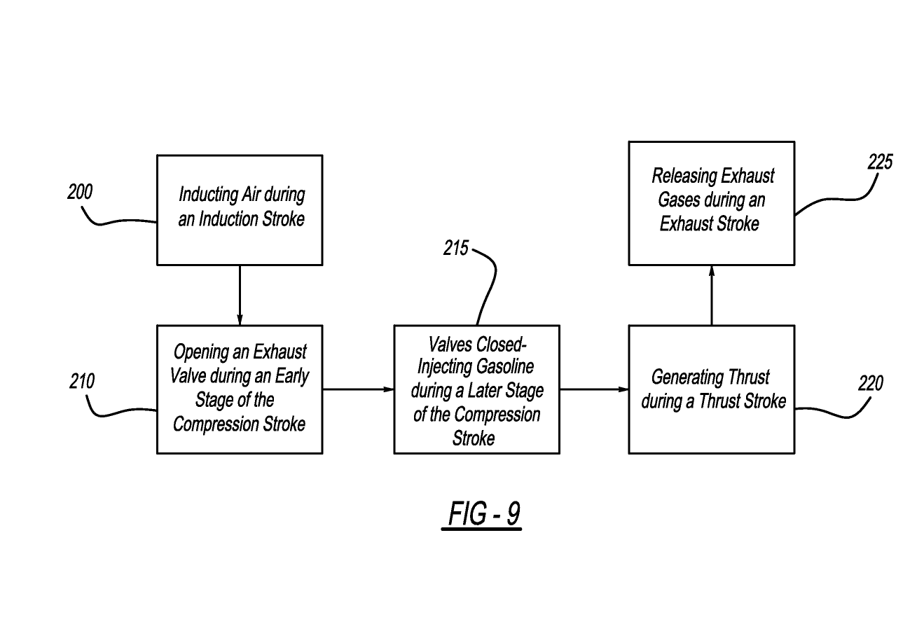

Referring to FIG. 9, a flowchart illustrating a methodology for controlling the engine cycle of a DIG engine 16 is provided. In this example, the DIG engine 16 is a 4-stroke engine, although other cycles are contemplated, and the number of strokes is non-limiting. The methodology begins at block 200 with the step of inducting air as shown at 70 during an induction stroke into a combustion chamber 74 by opening an induction valve 26 while an exhaust valve 28 is closed, via downward movement of the piston.

Next, the methodology advances to block 210 with the step of opening the exhaust valve 28 a first predetermined amount 76 during an early stage of the compression stroke. The valve 28 is opened for a predetermined period of time, and then closed due to rotation of the camshaft, as previously described. The exhaust valve 28 is closed while the piston is still moving upwards. The opening of the exhaust valve 28 at this time releases air and through heat transfer, a predetermined amount of the heat from the cylinder 22, such as from the cylinder wall, to reduce the buildup of heat within the cylinder. The reduction of temperature in the cylinder enables the engine to have a higher compression ratio than in a conventional engine.

The methodology further advances to block 215 with the step of injecting fuel 84 into the combustion chamber 74 via a fuel injector 66. In this example, the gas is injected during a later stage of the compression stroke while the induction valve 26 and exhaust valve 28 are closed. The piston continues to move upwardly to compress the air-fuel mixture. You better add ‘valves are closed’ into block 215, just like block 315 in FIG-10.

Further, the methodology advances to block 220 with the step of igniting the fuel-air mixture to generate thrust during the thrust (i.e. thrust, power) stroke while both the induction valve 26 and exhaust valve 28 are closed. The methodology advances to block 225 with the step of opening the exhaust valve 28 a second predetermined amount 88 to release exhaust gases through the exhaust channel 82 during an exhaust stroke. The induction valve is closed. The cycle is periodic, and continues in order to generate power.

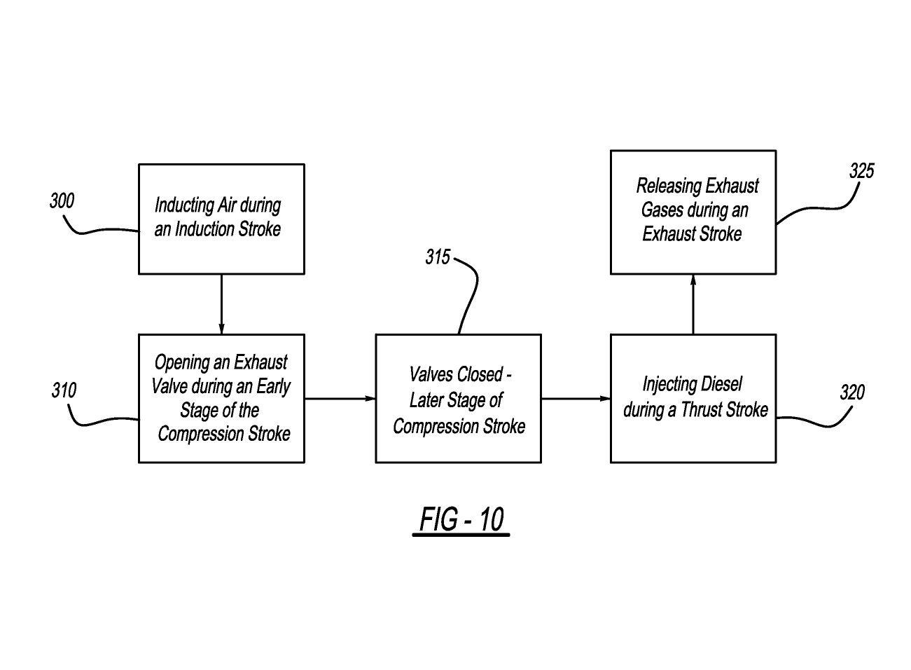

Referring to FIG. 10, a flowchart illustrating a methodology for controlling the engine cycle of a CI engine 60 is provided. In this example, the CI engine is a 4-stroke engine, although other cycles are contemplated, and the number of strokes is non-limiting. The methodology begins at block 300 with the step of inducting air during an induction stroke into the combustion chamber 74 as previously described. For example, an induction valve 26 may be opened while an exhaust valve 28 is closed due to rotational movement of the camshaft.

Next, the methodology advances to block 310 with the step of opening the exhaust valve 28 a predetermined first amount 78 during an early stage of the compression stroke. The exhaust valve 28 is held open for a predetermined period of time during the compression stroke, and then closed. Air in the cylinder is compressed as the piston is still moving upwards. Advantageously, opening of the exhaust valve at this time to provide for the egress of air through the exhaust channel 82 removes heat from the interior of the cylinder such as the cylinder wall due to heat transfer. The removal of heat thus reduces the temperature within the cylinder. As a result, the average working temperature inside the cylinder of the engine 15 will be substantially decreased. In addition, the heated gas within cylinder 22 may expand about 40-50 times of its compressed volume. Further, heat removal results from pure air cooling during the early state of the compression stroke and the lower temperature exhaust gas cooling during the later stage of the thrust stroke and during the exhaust stroke. The engine may be cooled without the need for another component, such as a water cooling system.

The methodology further advances to block 315 and continues with a later stage of the compression stroke. The induction valve 26 and exhaust valve 28 remain closed. The piston continues to move upwards to compress the air.

The methodology advances to block 320 and includes the step of injecting fuel 84 into the combustion chamber 74 and the fuel is ignited by the hot compressed air. The hot burning gas pushes the piston moving downwards. This is the thrust stoke. For example, diesel fuel may be injected via a fuel injector 66 when the piston 20 is at the top of its position and ends during a thrust stroke. In an example, both the induction valve 26 and exhaust valve 28 are closed during the thrust stroke as previously described. The methodology advances to block 325 with the step of releasing exhaust gases 80 during an exhaust stroke while the exhaust valve 28 is open a second predetermined amount 88 due to the rotational movement of the camshaft 38.

As a result of the innovative timing of the predetermined opening and closing of the induction valve 26 and the exhaust valve 28 during various strokes of the piston 20 as described herein, the engine is inherently cooled.

1. A multi-stroke engine comprising:
a cylinder formed within an engine block;
a piston movably disposed within the cylinder, wherein a combustion chamber is formed in a space between the piston and a cylinder head;
an injector disposed within the engine cylinder head for supplying fuel into the cylinder;
an intake valve disposed within an intake opening formed in the engine;
an exhaust valve disposed within an exhaust opening formed in the engine;
an actuator connected to the piston, wherein movement of the piston causes the actuator to open the exhaust valve a first predetermined amount at a beginning of the compression stroke of the piston to vent air through an exhaust channel formed in the engine and to close the exhaust valve after a predetermined period of time within the compression stroke of the piston.

2. The engine of claim 1, wherein the actuator opens the exhaust valve a second predetermined amount during an exhaust stroke of the piston to vent exhaust gas through an exhaust channel formed in the engine.

3. The engine of claim 1, wherein the actuator is a camshaft having an exhaust cam mounted to a shaft.

4. The engine of claim 3, wherein exhaust cam includes a first arcuate edge and a second arcuate edge, and the first arcuate edge is greater than the second arcuate edge.

5. The engine of claim 1, wherein the engine is a diesel engine.

6. The engine of claim 1, wherein the engine is a direct injected gasoline engine.

7. The engine of claim 1 wherein the engine is a four stroke engine having an induction stroke, a compression stroke, a thrust stroke and an exhaust stroke.

8. The engine of claim 7, wherein an exhaust cam has a small nose and a large nose, and the cam small nose opens the exhaust valve at the beginning of a compression stroke of the piston, and the cam large nose opens the exhaust valve during the exhaust stroke.

9. The engine of claim 8, wherein the first predetermined amount that the exhaust valve is opened during the beginning of the compression stroke is less than the second predetermined amount that the exhaust valve is opened during the exhaust stroke.

10. A method of a controlling operation of a multi-stroke engine, said method comprising the steps of:
introducing air into a combustion chamber formed in an engine cylinder via an induction valve; opening an exhaust valve a first predetermined amount during an early stage of a compression stroke to vent air through an exhaust channel formed in the engine cylinder and then closing the exhaust valve;
injecting fuel into the combustion chamber to generate power; and
opening the exhaust valve a second predetermined amount to release exhaust gas from the engine cylinder.

11. The method as set forth in claim 10 further comprising the step of inducting air during an induction stroke.

12. The method as set forth in claim 10 further comprising the step of generating power during a power stroke.

13. The method as set forth in claim 10 further comprising the step of exhausting gas during an exhaust stroke.

14. The method of claim 10, wherein the engine is a gasoline engine having an actual compression ratio of about 12:1-22:1 and an effective compression ratio of about 8:1-11:1.

15. The method of claim 10, wherein the engine is a diesel engine having an actual compression ratio of about 16:1-50:1 and an effective compression ratio of about 14:1-25:1.
